(19) United States
(12) Patent Application Publication
(10) Pub. No.: US 2012/0198829 A1
(43) Pub. Date: Aug. 9, 2012

(54) ENERGY MANAGEMENT SYSTEM USING HYDRAULIC COMPENSATOR FOR THE PRODUCTION OF ELECTRICITY FROM ONE OR SEVERAL NETWORKS OF CYNETIC ENERGY SOURCES

(75) Inventor: Francois Gagnon, Montrteal (CA)

(73) Assignee: FRANCOIS GAGNON, Montreal (CA)

(21) Appl. No.: 13/020,818

(22) Filed: Feb. 4, 2011

(51) Int. Cl. F16D 31/02

(52) U.S. Cl. 60/395

(57) ABSTRACT

The present invention is relates to the production of electricity by the integration of a network of kinetic energy sources. The purpose of the propose embodiments is to convert a plurality of energy sources of different potential to one hydraulic source that will be leveled by hydraulic compensator. The objective is to offer a stable electricity source.

All the incoming fluids are joint in a unique energy flow prior to the hydraulic motors that gone to drive the generators. The incoming fluid is regulate at constant pressure and flow to the hydraulic motor, the incoming variation of flow and pressure is regulate by and hydraulic compensator.

The generator is drive by a network of hydraulic motors that can supply many levels of power with the same rotation speed. The rotation of the main shaft that joint the hydraulic motors and the electric generator is keep constant by a flywheel equip with an electronic micro break. The electricity production is done by a network of generator that will deliver to the grid a synchronize current with fix voltage.

### FIELD OF THE INVENTION

The present invention is relates to the production of electricity by the integration of a network of kinetic energy sources. The purpose of the propose embodiments is to convert a plurality of energy sources of different potential to one hydraulic source that will be leveled by hydraulic compensator. The objective is to offer a stable electricity source.

### BACKGROUND OF THE INVENTION

The need to integrate a network of kinetic energy source is recent; the most forthcoming application is wind turbines and those are generally used alone for electricity production. Now we have multi sources systems that deliver a large quantity of uneven power, like a network of wind deflectors on the roof a building (patent pending CA2010001480) that can include an hundred turbines. The energy sources can also be a combination of few systems that offer different potentials over time; for example, an energy island can have both a wave energy network and a large number of wind turbines. Forthcoming energy needs will multiply the harnessing of lost energies that we will need to group in consistent power source. For example a large building may have roof wind turbines, corner wind turbines (like patent pending U.S. 61/387,603), and use also other kinetic energy sources like training room, down warding of elevators, the fall down of water waste, etc. . . . All those valuable source of energy will create instant variation in power offer/demand to the grid that will be difficult to manage, even for forthcoming intelligent grid system.

The present invention, using hydraulic compensators, will solve those problems and offer a consistent energy source that will be manageable both for the user and for the electricity grid.

### SUMMARY OF THE INVENTION

The present invention is base on the well-used fact that it is easy to produce a constant hydraulic pressure from a variable higher-pressure source. The best example is standard air compressors that easily supply a constant pressure of 100 Psi. when the pump start and stop within 125 and 175 Psi.

First, all the primary energy needs to be harness with an hydraulic system. This mean that the wind turbines, for example, have no generator, transformer or current rectifier; the energy harness is converted in hydraulic power by a pump directly drive from the turbine. Here the exhaust pressure is adapted to the power of the primary source of energy; in our example, a stronger wind will be managed at higher pressure by the system. We note that the choice of working pressure is not random but manage by the computer that will control the energy system.

As system may include a large quantity of apparatus, and few kinds of different sources. The preliminary set of apparatus is group in network that is expected to supply similar energy and work at same pressure. For example, a network of wind deflectors in the top of a building can all be connected to the same channel, but the four sides of a corner wind turbines arrangement for tall building must be connected separately as they will produce different result in regards of the direction of the wind.

All the incoming pipes are joint in a unique energy flow prior to the hydraulic motors that gone to drive the generators. The incoming fluid is regulate at constant pressure and flow to the hydraulic motor, the incoming variation of flow and pressure is regulate by and hydraulic compensator.

The generator is drive by a network of hydraulic motors that can supply many levels of power with the same rotation speed. The rotation of the main shaft that joint the hydraulic motors and the electric generator is keep constant by a flywheel equip with an electronic micro break. The electricity production is done by a network of generator that will deliver to the grid a synchronize current with fix voltage.

The present invention possesses numerous benefits and advantages.

The mechanism in every wind turbine will be simpler as they need no electric component. The basic installation cost and the maintenance expenses should be lower. The mechanism in the turbine will be less vulnerable, especially from water infiltration.

The electricity output will be relatively constant, changing by small step every minute and sometime staying stable for hours.

The electricity output could be synchronizing with grid alternative current, avoiding rectification and resynchronization of the power production.

### BRIEF DESCRIPTION OF THE DRAWINGS

In the appended drawings:

FIG. 1 is an overall view of this energy management system.

FIG. 2 show some energy graph at different stage of the energy system.

FIG. 3 show the way that different incoming flow can be add together in a final consistent flow.

FIG. 4 Is a schematic view of an hydraulic compensator for liquid flow.

FIG. 5 Show details of the system within hydraulic motors and generators.

### DESCRIPTION OF EMBODIMENTS OF THE INVENTION

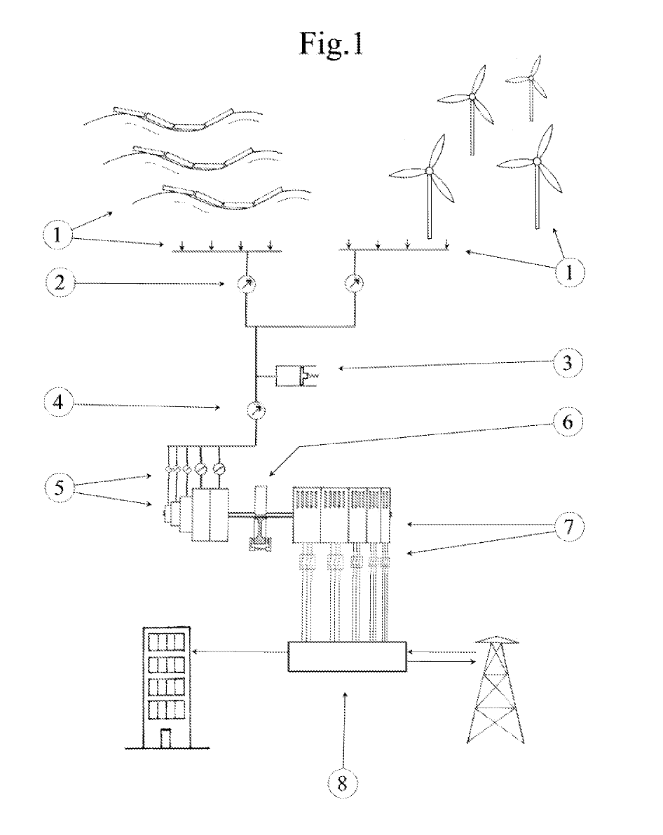

FIG. 1 illustrates the overall process. We have different source of kinetic energy in 1 that are group in network of similar capacity, for example few wind turbines on one side and wave power devices on the other one. Both incoming energy are balance by pressure regulators 2 to become compatible, they are joint after this first regulation. This new energy flow is still irregular, the pressure and the flow are regulating by another pressure and flow regulator 4, and the hydraulic compensator 3 thus absorbs the variation in incoming fluid. In 5 the regulated hydraulic flow is directed in one or more hydraulic motors in order to produce a fix rotation speed and torque to the generators. The flywheel 6 is equipped with electronic brake that keeps speed rotation of the generators in phase with the grid. The system use one or more of the generators 7 to produce a fix electricity output according to the energy supply by the hydraulic fluid. The power produce by the generator is linked to the main electricity control of the building 8. The system feed first the need of the building and when available, add power to the grid.

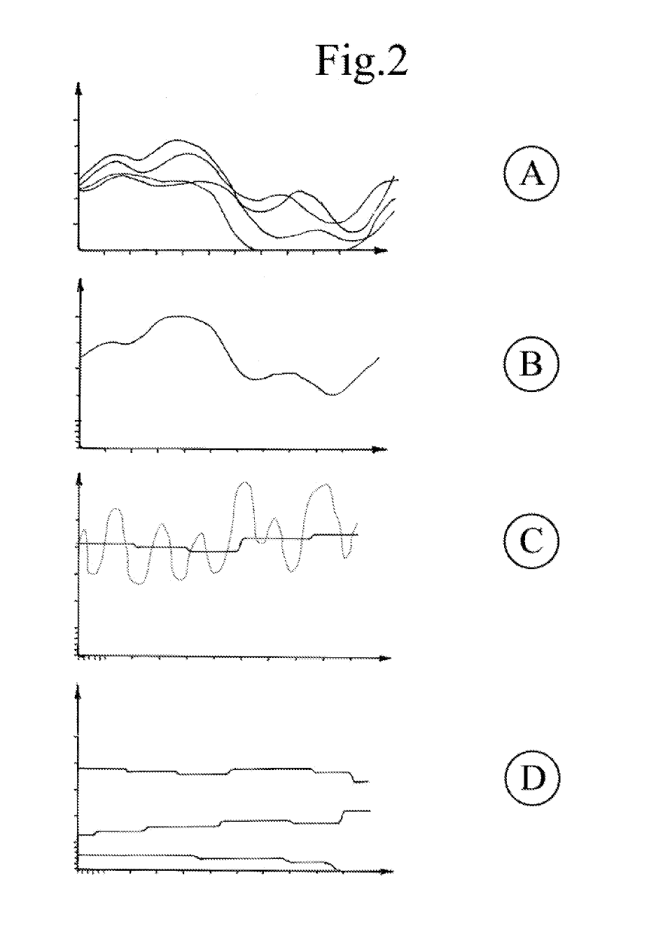

The FIG. 2 shows how the pressure and the energy that it carries change in the system. In the graph A we have the power curve of four wind turbines that have different position in a close area, here the vertical axis is the power and the horizontal is the time. Wind is relatively random and come in waves; the four power curves have some similarity, but are all different. As wind change relatively rapidly, we can figure the graph A represent a 15 or 25 seconds period.

The graph B of FIG. 2 represent the addition of the incoming energy of the four sources of the graph A. Here the time scale does not vary, but I energy scale is compress for addition. It is important to mention here that the energy carry by the fluid is a factor of the pressure and the flow; this addition of energy from many sources will increase overall flow with small pressure variation. This curve is already more smooth than previous one, but cannot be consider as easy to manage by the grid. This curve also represent result for what is already disclose as a system to joint energy of few wind turbines to one generator by the way of an hydraulic transport of energy.

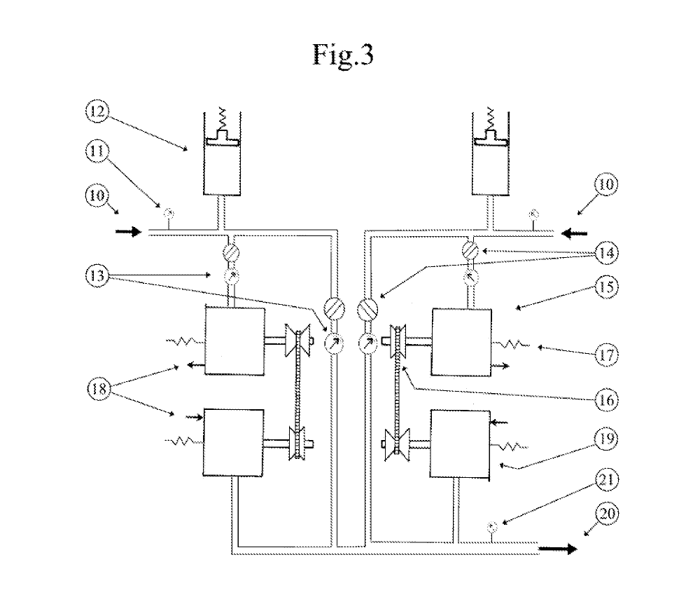

The graph C of FIG. 2 represent the first transformation of the incoming energy; here time is compress and overall graph represent a 4 or 5 minutes period. As we can see in FIG. 3, every incoming group with similar energy potential will have a first hydraulic compensator 12 that regulate the incoming flow 10 with the pressure controller 13. The dot curve of the graph C represent the incoming energy, and the straight curve the outgoing energy after transformation by the compensator 12 and the valve 13. The size of the compensator 12 will be chose in order to allow the pressure valve to change only once a minute, as per show in graph C, but pressure may stay stable for a longer period.

The graph D of FIG. 2 show three different outgoing energy flow from network with different potential. We can see first that the addition of those energy flows will produce a smooth curve that will have a lot of little variations that will need to be compensate again in the system. As every subsystem work with a specific pressure, the grouping of their energy will need a pressure normalization that will be explain in FIG. 3.

Now referring to FIG. 3 we will show how to add few subsystems with different energy potential. Some location will not need subsystem, like a low industrial building having only wind deflectors on is roof. Some other location may need many subsystems; as example, a tall building may have a corner wind turbines network with two kinds of apparatus and few smaller edifices all around, for a total of 10 to 15 subsystems to manage.

On FIG. 3 we have two incoming subsystems 10 that need to be added efficiently to produce an output 20. Every subsystem has a working pressure that will be optimize by the computer managing the overall system. This working pressure is regulated by valve 13, the incoming energy is measure both by the pressure gauge 11 and the sensors of level of fluid in the compensator 12. If both measurement in 11 and 12 are increasing, this mean that the system does not exit enough energy and the pressure valve 13 will slightly open to increase the output. On reverse if level is to low, the exhaust pressure will be reduce, stopping for a short time the outgoing of energy from the subsystem, until pressure in 21 drop enough to restart the flow, or until accumulation in 12 became sufficient.

Still on FIG. 3, we can see that each subsystem have two regulation valves 13 and two shutout valves 14. When possible, it is better to bypass the pressure transformation stage (15,16,17,18 and 19) to avoid energy lost.

When it will be require to balance income energy of the subsystems, we will have to increase, or decrease the pressure of incoming flow 10 in order to produce a consistent outgoing energy flow 20. In FIG. 3 we can see that the computer may choose that a subsystem will or will not use the pressure transformation system by opening one or the other shut valve 14. The transformation system presented is an arrangement of an hydraulic motor 15, a variable transmission pulley system 16 that is electronically adjusted in 17, and of a pump 19 that reintroduce fluid in the system at appropriate pressure. We will notice here that the volume of outgoing fluid of the motor 18 is different that the one used by the pump. As example, to transfer the same energy at half the pressure, you will need to double the flow.

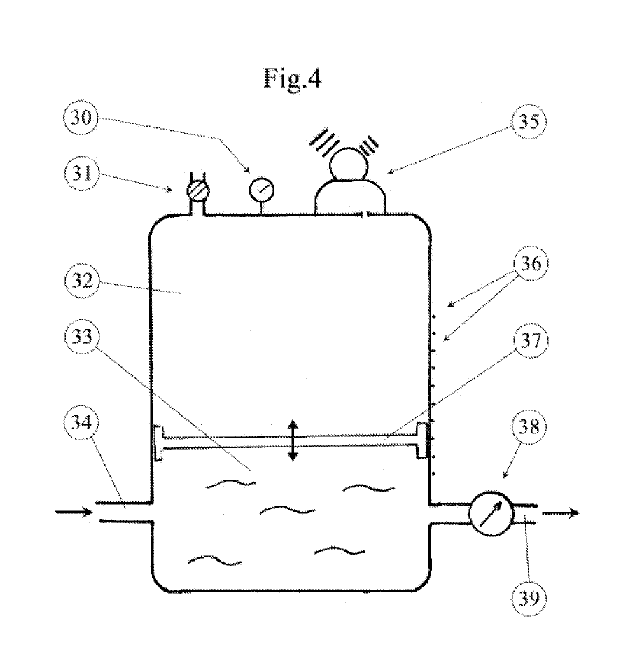

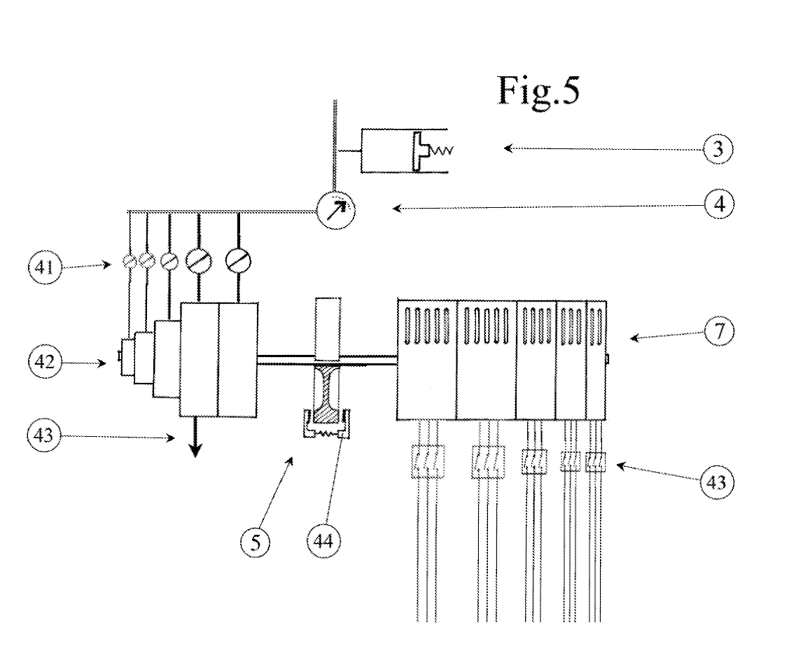

FIG. 4 is a schematic representation of an hydraulic compensator for liquid. In this arrangement the compress liquid entering the compensator in 34 and is temporary store in 33. The space 32 is fill with compress air. The pressure in 32, 33 and 34 are the same, when the energy include in the incoming flow 34 is higher than the one exhaust in 39, the volume 33 increase to compensate. When this append, the volume in 32 is reduce, and the pressure slowly increase, making both pressure in 32, 33 and 34 increase. The computer that manage the system will received information on incoming flow from pressure gauge 30 and level control of liquid 36. With the collected information's, the software may decide to change the output pressure in 38, change the outgoing flow in 41 of FIG. 5, increase the pressure in the compensator with the pump 35 or decrease it with the exhaust 31. We note that the separator 37 within the air 32 and the liquid 33 is optional and will depend on miscibility within air and the liquid use for the power transmission. Note also that a significatively larger volume of air 32 compare to the space allow to the liquid 33 will produce smaller pressure variation and thus a smoother operation.

FIG. 5 is a schematic representation of the hydraulic motor/electric generator arrangement. As we expect to deliver alternative electricity at a fix voltage, the speed rotation of the system will be invariable and keep constant with the flywheel system 5 that include an electronically control brake 44.

To produce a fix rotation for a wide range of power, FIG. 5 show in 42 that few hydraulic motors are set in series on the same driving shaft. Each motor have a different capacity for a fix rotation speed, that power potential can be resume as a volume. The power of the system is control by the pressure valve 4 and the open/shut valves 41 that are each linked to one motor; we can thus say:

fix pressure×fix volume=fix power.
This arrangement gives to the system the possibility to work with a wide rage of power. For example, we can have 6 motors 42 having respectively 1, 2, 3, 5, 10 and 20 liters per second of capacity and a system that optimally work with pressure within 3 to 20 bars. We thus have a system with a minimum power potential of 1 l./sec.×3 bars=3 units and a maximum torque of 41 l./sec.×20 bars=820 units, for a range of nearby 300 from the smallest to the largest power delivery.

This hydraulic motors system is very versatile. First the same energy can be delivering from different incoming pressure. For example, 60 units of power can be produce at 10 bars with the 2 motors using 1 and 5 liters per second, but it could also be produce with the motor using 3 liters per second at 20 bars, or the motor using 2 l./sec. At 30 bars. This flexibility is important as some sources may produce high pressure with low volume, like the energy harness from an elevator that going down, or a low pressure system with variable volume like wind turbine will do with relatively low wind.

This system is also versatile as it allows fine adjustments. The volume of fluid use by the motors 42 is fix for a specify rotation speed, but the pressure can be adjusted with precision in 4. For example, the system can deliver a fix power with an arrangement of motors using 16 l./sec. at 6.5 bars, but the managing computer can also adjusted the incoming pressure to 6.6 or 6.62 bars if require for example when the voltage from the grid vary at peak hour.

Still on FIG. 5, the electricity generators assembly 7 is similar to the motors one. Each generator has a specific capacity in voltage and power in regards of the fix incoming rotation produce by the motors 42. Each generators 7 run free or drive electricity to the grid according to their contactor 43 position. Each generator has a specific power that is easy to add to deliver a wide range of output. For example, we can have seven generators align with respective power of 10, 20, 40, 80, 160, 320 and 320 Kwatts; this system can thus generate power in multiple of 10 from 10 to 950 Kwatts.

Still on FIG. 5, the objective of the system is to supply electricity at a stable rate. With relatively stable incoming from harnessing subsystems, the electricity output will be stable at a lightly lower rate that the energy input, leaving the pressure and volume in compensator 3 increase slowly. When the volume in compensator is near the maximum, the managing computer lightly increases the electricity output to slowly use the energy store in the compensator. This back and forth movement should induce only small variations on output, and this only once every few minutes.

There is two different ways to build this hydraulic system that depend on the fluid medium choose, air or liquid. The main difference between the two mediums is that hydraulic fluid can carry more energy in smaller pipes, but need a return system. Some installation will work better with liquid, some other with air.

The liquid system advantages are: 1—It is more compact on all applications, smaller pump in the energy sources, smaller pipe to run the energy flow, smaller drive motor. 2—With appropriate piping, the energy lost in transportation is relatively small.

The liquid system weaknesses are: 1—There is need for a double pipe system everywhere. 2—The cost of hydraulic liquid can be an obstacle for spread system, unless water with emulsion can be used. 3—Water base liquid cannot be used where temperature get to low, and viscosity of hydraulic fluid increase when temperature is low.

The pneumatic system advantages are: 1—Single piping. 2—No low temperature problem. 3—No risk of hydraulic liquid lost, the energy transportation medium is free. 4—The hydraulic compensator is virtual, the size of the piping will be significatively increase to reduce friction, the resulting volume will act as compensator.

The air system weaknesses are: 1—when compressing air, a part of the energy harness is lost in heat, the lost increasing in proportion with working pressure. 2—To avoid heat lost in transportation, the pipe will require appropriate insulation, increasing the installation cost. 3—Energy lost in heat may be more important if balancing station like FIG. 3 is require. 4—Air motors are noisy and will have to be managing in close room.

The energy lost in heat of air system can be partly counterweigh if the hot air exhaust 43 from motors 42 in FIG. 5 is use to heat sanitary water, which could be done 12 months per year, and completely recycle when heating building is require in cool season.

The stability of this energy system can also be wildly improved by an electric energy management system like U.S. patent pending Ser. No. 12/840,997. In this case the output electricity of the hydraulic system is use at an average of 10 to 20% to reload the batteries. This mean that the output of the hydraulic system may vary of 5 or 30% without effect on the grid, and the cumulative energy store in the batteries over the day is give back to the grid at peak hours, eventually with better purchase rate.

1. An energy management system can be couple with hydraulic system to harness renewable kinetic energy; the objective of this management system is to offer a smooth energy source to the grid.

2. The energy management system of claim 1 use pressure valves and hydraulic compensators to regulate the energy flow of the fluid used.

3. The energy management system of claim 1 uses a plurality of hydraulic motors to produce a rotary torque of constant speed.

4. The pluralities of motors of claim 3 are mounted on the same shaft in order to be used alone or in-group.

5. Each motor of claim 3 is control by the energy management system with his own shut of valve.

6. The rotary speed of the shaft of claim 4 is control by the energy management system of claim 1 and regulate with the use of an appropriate flywheel equipped with electronic brake.

7. The rotary shaft of claim 4 drives a plurality of electric generators in order to produce electricity.

8. The electric generators of claim 7 produce alternative electricity in phase and with appropriate voltage to be couple with the grid.

9. The electric generators of claim 7 work one at the time or in-group in order to supply the fix power calculated by the energy management system of claim 1.

10. The renewable source of kinetic energy of claim 1 can be group in subsystem of different potential.

11. The pressure of the different subsystems of claim 10 can be balance by the energy management system of claim 1 to produce one consistent flow to the hydraulic motors of claim 3.

12. The pressures of the different subsystems of claim 10 are transform to an average pressure by the meaning of hydraulic motors and pumps equip with variable pulleys.

13. The flow of hydraulic fluid can bypass the system of motor/pump of claim 12 when not require, in order to reduce energy lost.

14. The hydraulic system to harness kinetic energy of claim 1 can use liquid or air as fluid to carry the energy.

15. The hydraulic energy management system of claim 1 can be use with an electric energy management system that use a plurality of batteries in order to maximize the reliability and consistency of the electricity output.
